(19) United States
(12) Patent Application Publication
(10) Pub. No.: US 2026/0365004 A1
(43) Pub. Date: Nov. 19, 2026

(54) Vehicle roof having a wind-deflector apparatus

(71) Applicant: Webasto SE, Stockdorf (DE)

(72) Inventors: Grégoire PIROUX, Stockdorf (DE); Johannes HUBER, Stockdorf (DE); Thomas WILLERER, Stockdorf (DE)

(21) Appl. No.: 19/680,056

(22) Filed: May 18, 2026

(30) Foreign Application Priority Data
May 19, 2025 (DE) 10 2025 119 359.2

(51) Int. Cl. B60J 7/22

(52) U.S. Cl. CPC B60J 7/22

(57) ABSTRACT

A vehicle roof having a wind-deflector apparatus, which has an open-out wind-deflector lamella and an adjusting device for adjusting the wind-deflector lamella, wherein the wind-deflector lamella can be adjusted between a rest position, in which it forms a roof portion of a roof surface of the vehicle roof, and at least one functional position, in which it has been pivoted out, by way of its rear edge, relative to the roof surface. Provision is made for the adjusting device to have an actuating structure, and for the wind-deflector lamella to be both inherently rigid and formed so as to be elastically deformable in such a way that, when the wind-deflector lamella is being pivoted out into its functional position, the adjusting device deforms the wind-deflector lamella by the actuating structure and in particular imparts a convexly curved configuration to the wind-deflector lamella.

### CROSS-REFERENCE TO RELATED APPLICATIONS

This application claims the benefit of German patent Application No. 10 2025 119 359.2, filed May 19, 2025, which is incorporated herein by reference in its entirety.

### TECHNICAL FIELD

The disclosure relates to a vehicle roof having a wind-deflector apparatus, which has an open-out wind-deflector lamella and an adjusting device for adjusting the wind-deflector lamella, wherein the wind-deflector lamella can be adjusted between a rest position, in which it forms a roof portion of a roof surface of the vehicle roof, and at least one functional position, in which it has been pivoted out, by way of its rear edge, relative to the roof surface.

### BACKGROUND

DE 102 17 659 B4 has disclosed a vehicle roof which is of the type in question and has a wind-deflector apparatus. The wind-deflector apparatus comprises a wind-deflector lamella which is mounted such that it can be pivoted about a front pivot axis and which can be adjusted by means of an actuating mechanism between a pivoted-down rest position and a pivoted-out functional position. On each of the two lateral narrow sides of the wind-deflector lamella, the actuating mechanism has an opening-out lever, which on the one hand is mounted in a pivotable manner on a roof-mounted bearing block and on the other hand is coupled to the wind-deflector lamella by means of a slip-joint arrangement. An opening-out carriage, which is mounted in a displaceable manner on a guide rail oriented in the longitudinal direction of the roof, actuates the opening-out lever for the purpose of pivoting the wind-deflector lamella. The wind-deflector lamella influences the air flow over the vehicle roof by way of its respective pivot position set by the opening-out carriage.

### SUMMARY

It is an object of the disclosure to provide a vehicle roof which has been mentioned in the introduction and is improved in respect of the capability of the wind-deflector apparatus to influence the air flow.

The object is achieved according to the disclosure, in respect of the vehicle roof mentioned in the introduction, in that the adjusting device has an actuating structure, and in that the wind-deflector lamella is both inherently rigid and formed so as to be elastically deformable in such a way that, when the wind-deflector lamella is being pivoted out into its functional position, the adjusting device deforms the wind-deflector lamella by means of the actuating structure and in particular imparts a convexly curved configuration to the wind-deflector lamella.

Advantageous embodiments of the vehicle roof according to the disclosure are specified in the dependent claims.

Since the wind-deflector lamella of the vehicle roof according to the disclosure is configured with an elastically or reversibly deformable structure, it is designed so that, in its functional position or operational position, it assumes an altered configuration intended in particular for optimal conduction of wind or air flow. This altered configuration of the wind-deflector lamella in its functional or operational position therefore differs from the configuration of the wind-deflector lamella in its rest position. The wind-deflector lamella according to the disclosure therefore differs from a prior-art wind-deflector lamella, which has an undeformable structure and maintains its configuration when it is adjusted from its rest position into its operational position.

The wind-deflector lamella of the vehicle roof according to the disclosure is inherently rigid in such a way that it maintains its configuration when, in its rest position, it forms a rigid portion or roof section of the roof surface, or of a transition region in front of the roof surface, and is matched in particular to the contour of the roof surface. The vehicle roof can have a roof system which has a roof opening and a panel, which can optionally close or at least partially expose the roof opening, or some other suitable closure unit. In this case, in its rest position, the wind-deflector lamella is arranged in front of the roof opening, as seen in the flow direction, and forms a rigid portion or rigid roof section of the roof surface, or of a transition region in front of the roof opening.

However, the wind-deflector lamella of the vehicle roof according to the disclosure is also formed so as to be elastically and reversibly deformable in such a way that it can be deformed, and altered in configuration, by means of the actuating structure. The wind-deflector lamella, of which the configuration in its rest position is matched in particular to the contour of the roof surface, has for example a curved configuration, but can also be formed with planar surfaces. By means of the actuating structure, the wind-deflector lamella can be deformed for example from its planar-surface, resting configuration into an in particular convexly curved configuration or functional configuration or can be deformed from its curved resting configuration into a differently curved functional configuration, which is curved for example to a greater or lesser extent.

The wind-deflector lamella is expediently formed with a continuously extending surface-area configuration and has a continuous surface. The wind-deflector lamella is formed for example from a plastic or from a composite material. The wind-deflector lamella has for example a plate-like configuration with essentially the same thickness over its surface-area extent. On the other hand, the wind-deflector lamella can also have at least one region of reduced thickness, this region expediently being intended as a deformation region for the elastic deformation of the wind-deflector lamella. The reduced thickness of the wind-deflector lamella is formed in particular by material reduction on the underside of the wind-deflector lamella.

According to a further embodiment, the wind-deflector lamella contains at least one region in which the material or the material properties of the wind-deflector lamella are selected or set so as to allow elastic deformation of the wind-deflector lamella in this region, wherein the material or the material properties of this region differ(s) from the material or the material properties of the rest of the wind-deflector lamella.

It is expediently the case that the wind-deflector lamella can be deformed or is deformed in such a way that it obtains or has a longitudinal curvature and/or a transverse curvature. The longitudinal curvature is a curvature in the flow direction or in the longitudinal direction of the roof or longitudinal direction. The transverse curvature is a curvature transverse to the flow direction or in the transverse direction of the roof or transverse direction. A longitudinal curvature combined with a transverse curvature is, accordingly, a three-dimensional or 3D curvature.

According to a further embodiment, the at least one region of reduced thickness forms a film hinge of the wind-deflector lamella. Such a film hinge defines the location or the region of deformation when the curvature of the wind-deflector lamella is being set by means of the actuating structure. Such a film hinge preferably extends in the transverse direction of the roof along the wind-deflector lamella.

It is expediently the case that, in the region of its front edge or directly at its front edge, the wind-deflector lamella is mounted on the roof by means of a bearing device. According to a preferred embodiment, the bearing device is formed in such a way that it retains the wind-deflector lamella in a fixed position. When it pivots out, the wind-deflector lamella deforms in relation to the fixed front edge. The wind-deflector lamella thus maintains its position at its front edge both in its rest position and in a pivoted-out, functional position.

On the other hand, according to a further preferred embodiment, the bearing device is formed in such a way that it retains the wind-deflector lamella such that it can be pivoted about a transverse pivot axis by means of a pivot bearing. The front edge of the wind-deflector lamella thus alters its position relative to the transverse pivot axis when the wind-deflector lamella is adjusted and pivots out. The front edge of the wind-deflector lamella performs a movement which is dependent on the position of the transverse pivot axis in relation to the front edge of the wind-deflector lamella. It is expediently the case that there is no need for any deformation of the wind-deflector lamella directly at its front edge. In particular, the deformability of the wind-deflector lamella is set in such a way that the deformation begins in the region of the front edge or in a region which is spaced apart from the front edge and has for example a film hinge.

According to a preferred embodiment, provision is made for the actuating structure to be arranged on an underside of the wind-deflector lamella. In an initial position, the actuating structure is positioned in such a way that it retains the wind-deflector lamella in its rest position. The actuating structure lifts and pivots the wind-deflector lamella out of its rest position on account of an adjusting movement of the adjusting device. It is expediently the case that the two lateral edges or edge sides of the wind-deflector lamella are free of any portions of the actuating structure, so that lateral installation space does not have to be provided for such portions. The actuating structure is expediently arranged in a region adjacent to the rear edge of the wind-deflector lamella and projects downward on the underside of the wind-deflector lamella.

Provision is expediently made for the actuating structure to subject the wind-deflector lamella to a bending moment which deforms the wind-deflector lamella. The actuating structure is guided in a movable manner along such an adjustment path that it causes both the wind-deflector lamella to pivot out and the wind-deflector lamella to deform. The deformation behavior of the wind-deflector lamella determines the way in which the bending moment is introduced onto the wind-deflector lamella. The bending moment which deforms the wind-deflector lamella is applied to the wind-deflector lamella essentially in the region of its rear edge, but can also be applied in a central region as well as in a region adjacent to the front edge of the wind-deflector lamella. The bending moment which is necessary for deformation takes place by forces being introduced at a distance from the lamella-supporting bearing device at the front edge of the wind-deflector lamella.

The actuating structure preferably contains at least one lever arm, which on the one hand is connected in a bending-moment-transmitting manner to the wind-deflector lamella at a distance from the bearing device, which is assigned to the front edge of the wind-deflector lamella, and on the other hand is mounted in a pivotable manner on the roof by way of an actuating-structure bearing or lever-arm bearing. The lever arm is fitted in a fixed and rigid manner on the wind-deflector lamella. On the other hand, it is also possible for the lever arm to be pivotable relative to the wind-deflector lamella over a certain pivoting path. In this way, it is possible to set bending-moment transmission in dependence on the pivot position of the lever arm relative to the wind-deflector lamella. The pivoting path is set to the settable deformation of the wind-deflector lamella and is limited for example by at least one stop. Furthermore, the lever arm can also be formed with such an elastic deformability which is coordinated with the transmission of the necessary bending moment. By way of example, the lever arm represents one embodiment of the actuating structure. The actuating structure can also be formed in other configurations.

The lever-arm bearing is for example a rotary bearing or pivot bearing. The lever-arm bearing is mounted in a variable position on the roof, for example on a guide such as a roller guide or sliding guide. Movement of the lever-arm bearing along the sliding guide generates the pivoting movement of the lever arm for the purpose of opening out the wind-deflector lamella. The orientation of the movement path of the lever-arm bearing or of the sliding guide is coordinated with the necessary movement of the lever arm for the purpose of pivoting out the wind-deflector lamella during its intended deformation. The sliding guide can be formed both linearly and in a curved manner.

The lever-arm bearing can also be guided on the necessary movement path by means of a link device or a joint mechanism, as an alternative or in addition to the guide mentioned above.

It is particularly preferred for the lever-arm bearing to be arranged in an adjustable manner along a longitudinal roof guide. The lever-arm bearing can be actuated in particular by an adjusting device of a, or of the, closure unit or of the panel, the closure unit being provided for optionally closing or exposing the roof opening of the vehicle roof. The lever-arm bearing is expediently arranged on a bearing carriage, which is mounted in a displaceable manner on the roof-mounted guide. The lever-arm bearing can also be formed in one piece or in one portion with the bearing carriage.

The lever-arm bearing or the bearing carriage can preferably be coupled to and uncoupled from the adjusting device of the panel by means of a locking-block mechanism. During an initial opening movement of the panel, the lever-arm bearing or the bearing carriage is coupled to the adjusting device of the panel until such time as the wind-deflector lamella has been pivoted out of its rest position into its functional position. Subsequently, the lever-arm bearing or the bearing carriage is uncoupled from the adjusting device of the panel by means of the locking-block mechanism and is retained in a fixed state on the guide. Such a locking-block mechanism is known for example from DE 101 46 285 A1.

On the other hand, it is also possible for the lever-arm bearing to be designed such that it can be adjusted by means of a dedicated drive device.

According to a further embodiment, provision is made so that, as seen in the transverse direction of the roof along the wind-deflector lamella, the actuating structure or the lever arm extends over the width of the wind-deflector lamella. The overall deformation of the wind-deflector lamella takes place by way of this actuating structure.

On the other hand, provision can also be made so that, as seen in the transverse direction of the roof along the wind-deflector lamella, the actuating structure has at least two actuating-structure units or two lever arms, which can be adjusted differently in relation to one another. In this way, the overall deformation of the wind-deflector lamella can be set by the deformation of the wind-deflector lamella in the regions of the at least two actuating-structure units or two lever arms. It is expediently the case that each actuating-structure unit or each lever arm is assigned a dedicated adjusting movement, which differs in particular from an adjusting movement of an adjacent actuating-structure unit or of an adjacent lever arm.

According to a further embodiment, provision is made for the lever-arm bearing to have a pivotable bearing spindle, which extends essentially over the width of the wind-deflector lamella and on which the actuating structure or the lever arm is fixed or with which the actuating structure or the lever arm is formed in one piece. The bearing spindle is formed for example by a tube. The bearing spindle is expediently subdivided in the longitudinal direction into a plurality of bearing-spindle sections, which are each connected to an actuating structure or a lever arm and can be adjusted with dedicated adjusting movements in each case. As a result, the overall adjustment and deformation of the wind-deflector lamella can be performed by the respective movements of the individual actuating structures or lever arms.

Provision is expediently made for the adjusting device to be actuated in dependence on the speed of the vehicle and/or on the air flow to be conducted via the wind-deflector lamella. Furthermore, provision can also be made for the adjusting device to be actuated in a predetermined manner, in particular in dependence on a respective position of the closure unit or of the panel or by a control-logic means, which for example is fixed or can be set or is adjustable.

The wind-deflector lamella is preferably made of a plastic such as PP or PU or of silicone or of a composite material, which can be both thermosetting and thermoplastic. In particular, the material is selected in such a way that, during deformation, it allows high levels of expansion at high temperatures without deforming irreversibly. The wind-deflector lamella can be produced both in an opaque and in a transparent configuration.

Axis- and direction-specific designations such as for example “front/forward” and “rear/rearward”, “top/upward” and “bottom/downward”, “outside/outward” and “inside/inward”, “lateral” and “longitudinal” or in the longitudinal direction or in the x direction, and “transverse” or in the transverse direction or y direction, refer to a three-dimensional x-y-z vehicle-coordinate system, the x direction describing a longitudinal direction of the vehicle, the y direction describing a transverse direction of the vehicle and the z direction describing a vertical direction of the vehicle. This coordinate system also applies to the vehicle roof.

### BRIEF DESCRIPTION OF DRAWINGS

The disclosure will be explained in more detail hereinbelow on the basis of an exemplary embodiment of a vehicle roof according to the disclosure, with reference to the drawing, in which:

FIG. 1 shows an isometric view of a vehicle having an openable vehicle roof, which has a roof system with a panel arranged in a closed position in a roof opening, and having a wind-deflector apparatus, which has an open-out wind-deflector lamella arranged in a rest position in front of the panel;

FIG. 2 shows an isometric view of the vehicle from FIG. 1, wherein the panel has been shifted rearward and the wind-deflector lamella has been pivoted out into a functional position, with the roof opening exposed;

FIG. 3 shows a schematically illustrated side view of the wind-deflector lamella in the rest position, the wind-deflector lamella being mounted on the vehicle roof such that it can be opened out by means of an adjusting device;

FIG. 4 shows a schematically illustrated side view of the wind-deflector lamella pivoted out into a functional position by means of the adjusting device;

FIG. 5 shows a schematically illustrated side view of a second embodiment of a wind-deflector lamella in a rest position, the wind-deflector lamella being mounted for opening-out action on the vehicle roof and being adjustable by means of an adjusting device;

FIG. 6 shows a schematically illustrated side view of the wind-deflector lamella illustrated in FIG. 5, this time in a pivoted-out, functional position; and

FIG. 7 shows an isometric view of the vehicle from FIG. 2, wherein the wind-deflector lamella pivoted out into a functional position has a concave deformation which is different from that in FIG. 2.

### DETAILED DESCRIPTION

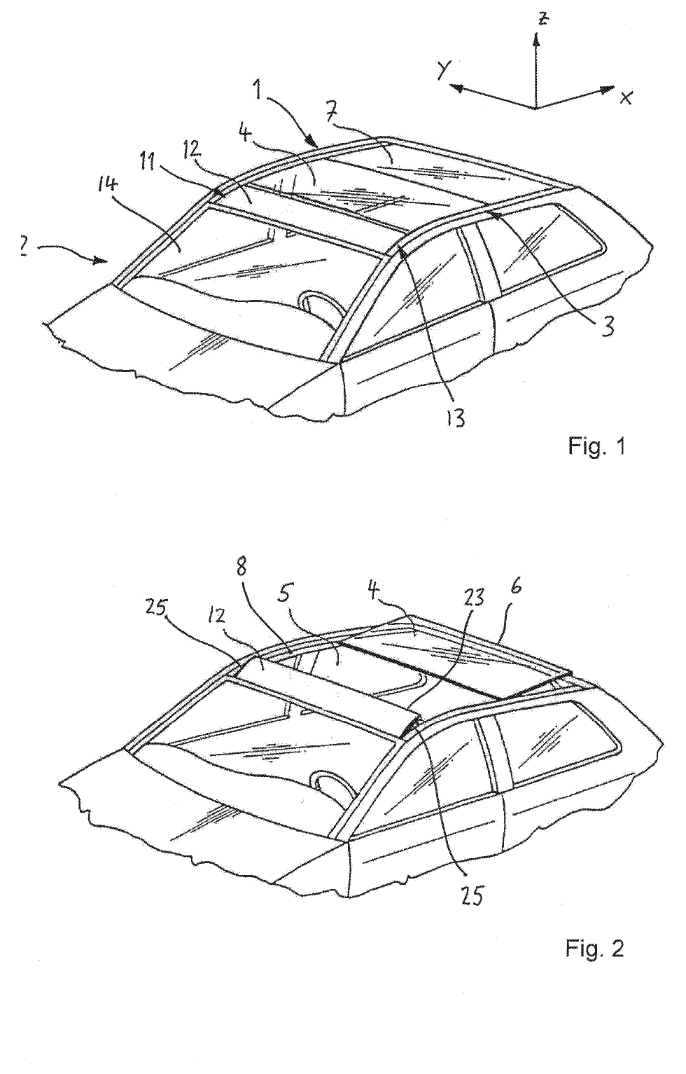

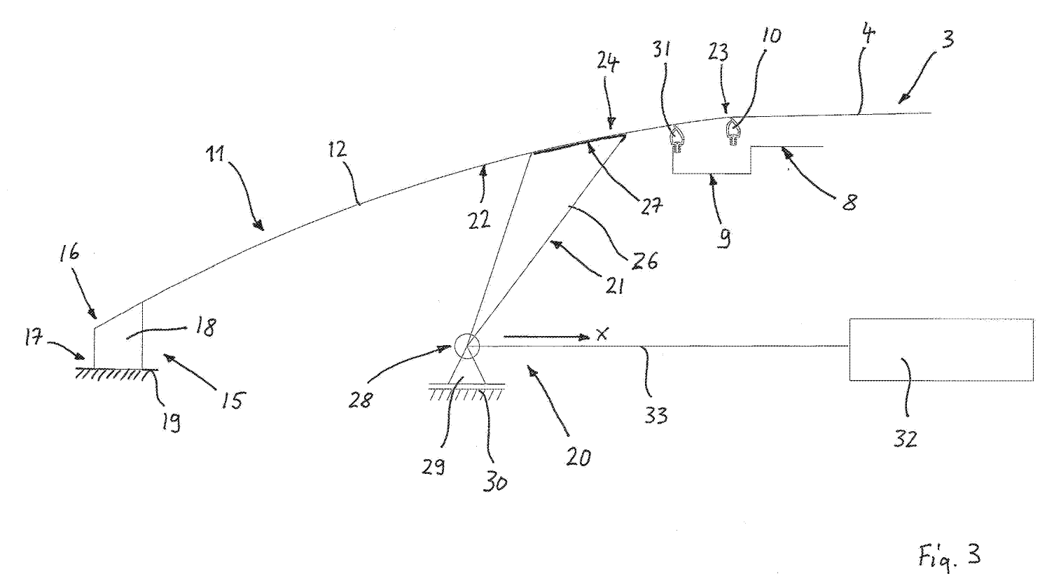

An openable vehicle roof 1 of a vehicle 2, such as for example a passenger vehicle, has a roof system 3 with a panel 4, which can be raised, by way of its rear edge 6, from a closed position (FIG. 1) in a roof opening 5, and adjusted into a ventilating position, and can be displaced, by way of its rear edge 6, from the raised, ventilating position into an open position (FIG. 2) over a rear roof surface 7, which follows behind the roof opening 5 as seen in the longitudinal direction x of the vehicle or roof. Such a roof system 3 is for example an externally guided sliding roof/sunroof or a spoiler roof. The rear roof surface 7 can be formed for example by a vehicle-mounted roof, by a portion of the roof system 3 or by a movable roof portion.

The roof system 3 expediently has a roof-system frame 8, which is essentially rectangular and on which the panel 4 is mounted in a movable manner. A drive device for adjusting the panel 4 is expediently also arranged on the roof-system frame 8. The roof-system frame 8 is fastened on the vehicle roof 1 or on a vehicle-roof frame. The roof-system frame 8 contains for example a water chamber 9 (FIG. 3) and a sealing arrangement 10, which seals the panel 4 in its closed position. A bearing device for adjustably mounting the panel 4 is known for example from DE 10 2014 014 171 B4.

The design of the vehicle roof 1 is largely symmetrical to a vertical longitudinal center plane of the vehicle roof 1, and so the following description is made essentially on the basis of the components on the left-hand half of the vehicle roof 1, as seen in the direction of travel.

A wind-deflector apparatus 11 contains an adjustable wind-deflector lamella 12, which in its rest position (FIG. 1) is arranged in front of the roof opening 5, as seen in the flow direction, and forms a rigid portion or roof section of the front roof surface 13, or of a transition region between a windshield 14 and the roof opening 5, and is matched to the contour of the roof surface 13. The wind-deflector lamella 12 has a for example curved configuration, wherein the curvature expediently follows the contour of the roof surface 13 and is in particular a convex curvature, which can extend in the longitudinal direction and/or in the transverse direction of the vehicle roof 1.

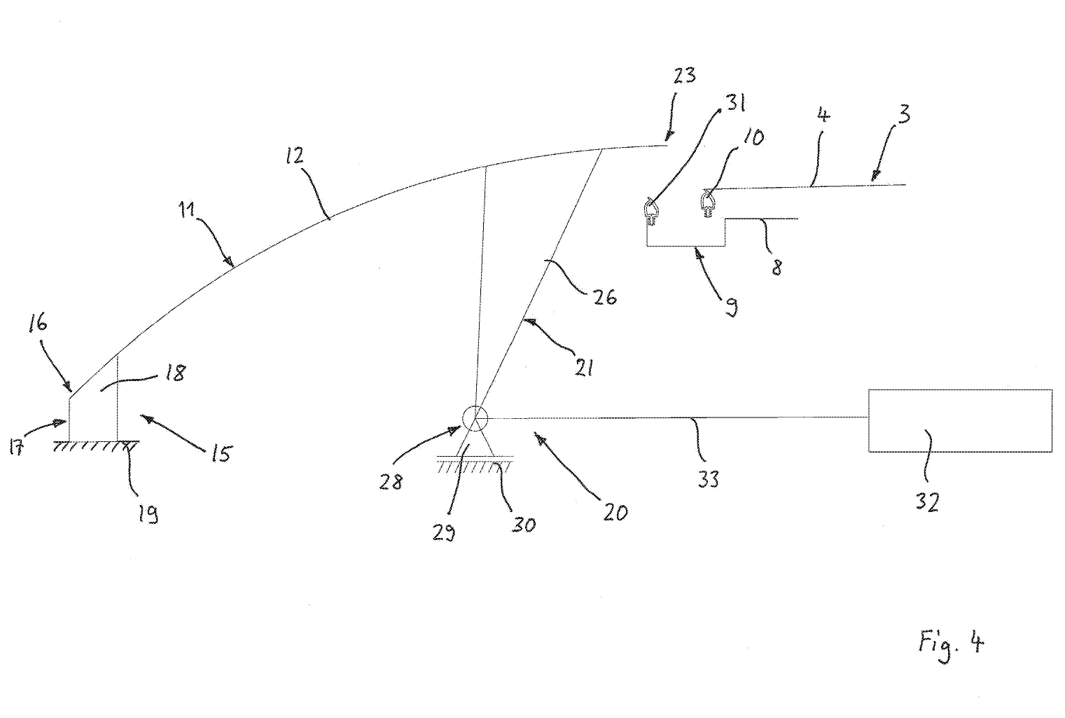

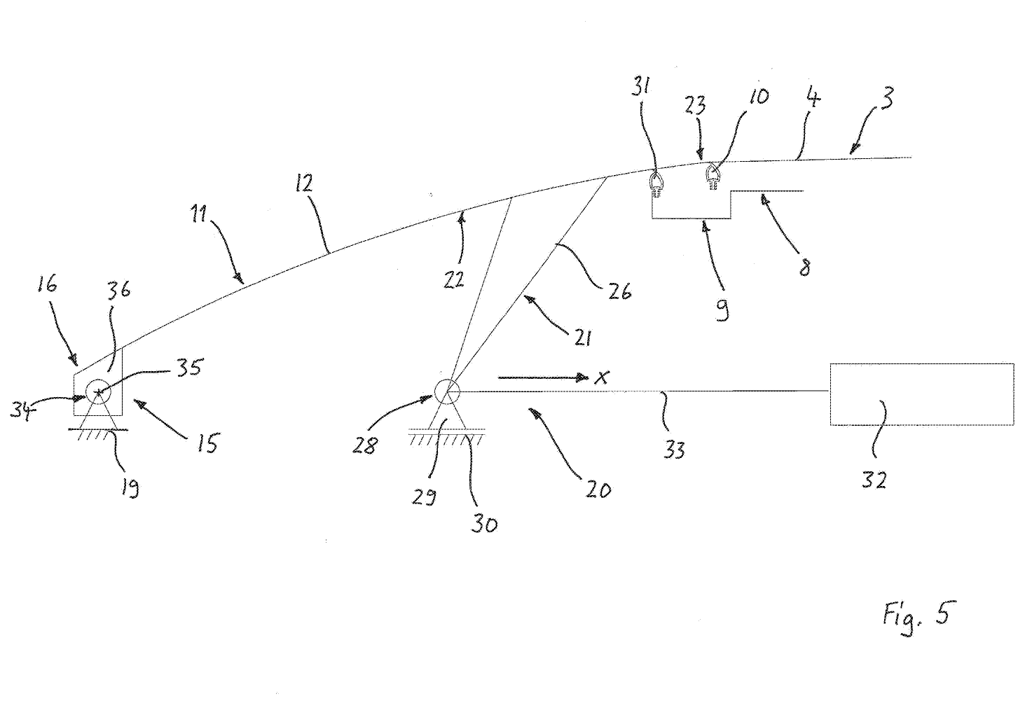

The wind-deflector lamella 12 is mounted on the vehicle roof 1 by means of a bearing device 15. According to a first embodiment (FIGS. 3 and 4), in the region of the front edge 16 of the wind-deflector lamella 12, the bearing device 15 has a fixed bearing 17, which retains the wind-deflector lamella 12 in its rest position. The fixed bearing 17 comprises a retaining structure 18 which is fixed to the roof, such as for example on a roof frame 19 or on a portion connected to the roof frame 19, e.g. by a screw connection, an adhesive connection or a plug connection or the like. The retaining structure 18 is for example a portion of the wind-deflector lamella 12 or a portion which is fitted on the wind-deflector lamella 12.

The wind-deflector apparatus 11 also contains an adjusting device 20 for adjusting the wind-deflector lamella 12 from its rest position into a functional position and back again into the rest position, it being possible to set functional positions in which the wind-deflector lamella is opened out to different extents. The adjusting device 20 has an actuating structure 21, which extends downward from the underside 22 of a region 24 of the wind-deflector lamella 12, this region being located adjacent to, and in front of, the rear edge 23 of the wind-deflector lamella 12. The actuating structure 21 expediently extends more or less over the entire width of the wind-deflector lamella 12. The two lateral edge sides 25 of the wind-deflector lamella 12 are expediently free of any portions of the actuating structure 21. The actuating structure 21 is for example in the form of a lever arm 26, which is fixed, at its head end, to the wind-deflector lamella 12 or is produced in one piece therewith. The lever arm 26 can also be formed with a supporting limb 27, by means of which it is fitted on the underside 22 of the wind-deflector lamella 12. In any case, the actuating structure 21 is arranged on the wind-deflector lamella 12 at a distance from the bearing device 15.

At its foot end, the actuating structure 21 or the lever arm 26 is mounted in a pivotable manner on the roof by means of a lever-arm bearing 28. The lever-arm bearing 28 is for example a rotary bearing or a pivot bearing. The lever-arm bearing 28 is mounted in a variable position on the roof, for example on a guide 30, e.g. a roller guide or a sliding guide, by means of a bearing carriage 29.

The wind-deflector lamella 12 is formed in an inherently rigid manner from such a material, and with such a structure, that it maintains its configuration when it is arranged in its rest position and is matched to the contour of the front roof surface 13. The wind-deflector lamella 12 here is in sealing contact, in the region of its rear edge 23, with a seal 31, which is arranged on a wall of the water chamber 9 of the roof-system frame 8.

However, the wind-deflector lamella 12 is also formed so as to be elastically and reversibly deformable in such a way that it can be deformed, and altered in configuration, by means of the actuating structure 21 or the lever arm 26. The wind-deflector lamella 12 has for example a planar-surface configuration or also a curved configuration. By means of the actuating structure 21, the wind-deflector lamella 12 can be deformed from its planar-surface or curved, resting configuration into an in particular convexly curved configuration or functional configuration or can be deformed from its curved resting configuration into a differently curved functional configuration, which is curved for example to a greater or lesser extent. The deformation takes place when the wind-deflector lamella 12 is being adjusted between its rest position and the respective functional position.

The bearing carriage 30 of the lever-arm bearing 28 is connected to a drive and actuating device 32, for example by means of a connecting element 33 such as a rod or a compressively rigid cable, and can be adjusted along the guide 30 by this drive and actuating device 32.

For the purpose of adjusting the wind-deflector lamella 12 from its rest position (FIGS. 1 and 3) into its for example fully pivoted-out, functional position (FIGS. 2 and 4), the drive and actuating device 32 moves the bearing carriage 30 of the lever-arm bearing 28 from its initial position along the guide 30, for example rearward in the x direction. The spatial progression of the guide 30 relative to the bearing device 15 is determined in such a way that, as the bearing carriage 29 moves, the lever arm 26 performs a pivoting movement about the lever-arm bearing 28 and at the same time subjects the wind-deflector lamella 12 to a bending moment which deforms the wind-deflector lamella 12. The bending moment which deforms the wind-deflector lamella 12 is applied to the wind-deflector lamella 12 by way of the lever arm 26 and deforms the wind-deflector lamella 12 in the desired manner. The set deformation behavior of the wind-deflector lamella 12 determines the way in which the bending moment is introduced onto the wind-deflector lamella 12. The wind-deflector lamella 12 is set in such a way that it remains undeformed at its front edge 16 and the deformation begins only at a distance from the front edge 16. On the other hand, the retaining structure 18 of the fixed bearing 17 can be formed with a certain level of elastic flexibility, so that, when the wind-deflector lamella 12 pivots out, it deforms to the extent required in this respect (illustrated in FIG. 4). The wind-deflector lamella 12 can maintain its undeformed configuration at its front edge 16 while it pivots out.

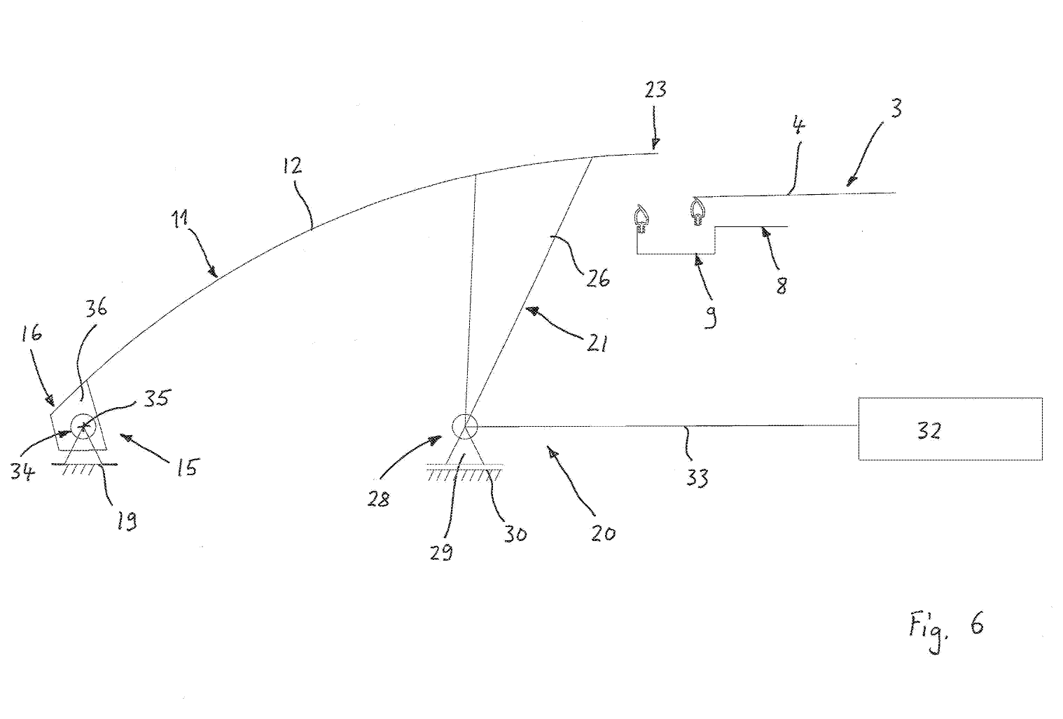

According to a modified embodiment (FIGS. 5 and 6), in the region of the front edge 16 of the wind-deflector lamella 12, the bearing device 15 has a pivot bearing 34, which bears the wind-deflector lamella 12 such that it can be pivoted about a transverse pivot axis 35. The pivot bearing 34 is connected to the wind-deflector lamella 12 via a retaining structure 36. When the wind-deflector lamella 12 pivots out, the adjusting device 20 pivots the wind-deflector lamella 12 about the transverse pivot axis 35. The wind-deflector lamella 12 is deformed in the desired manner by the actuating structure 21 in accordance with the set deformation behavior of the wind-deflector lamella, wherein its front region, in the vicinity of the front edge or of the bearing device 15, remains undeformed. The spatial progression of the guide 30 relative to the bearing device 15 is adapted correspondingly. Otherwise, this embodiment is the same as the first embodiment described with reference to FIGS. 3 and 4.

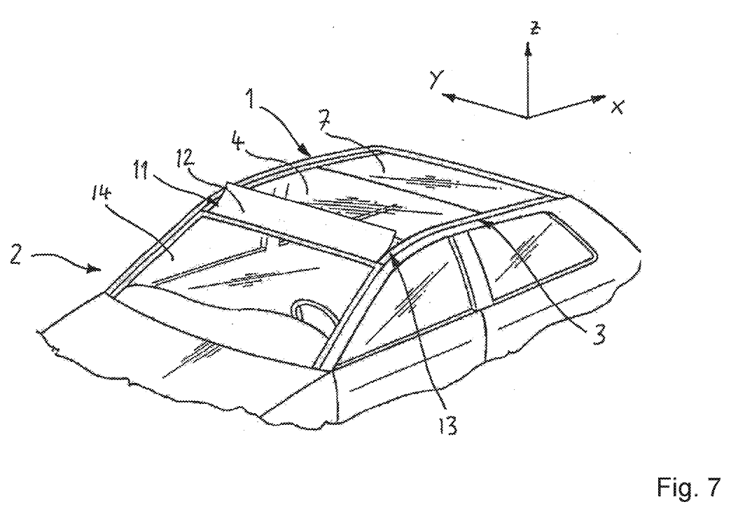

According to a further modified embodiment (FIG. 7), the wind-deflector lamella 12 is deformed in a flexible manner from its resting configuration into an in particular concavely curved configuration or functional configuration by means of the actuating structure 21. The retaining structure 18 retains the wind-deflector lamella 12 in a fixed and undeformed state at its front edge 16. The deformation of the wind-deflector lamella 12 takes place at a location following the fixed front edge 16. The drive and actuating device 32 moves the bearing carriage 30 of the lever-arm bearing 28 from its initial position along the guide 30, for example rearward in the x direction. The spatial progression of the guide 30 relative to the bearing device 15 is determined, and can deviate from the x direction, in such a way that, as the bearing carriage 29 moves, the lever arm 26 performs a pivoting movement about the lever-arm bearing 28 and at the same time subjects the wind-deflector lamella 12 to a bending moment which deforms the wind-deflector lamella 12, and which brings about such concave deformation of the wind-deflector lamella 12. In an alternative embodiment, the drive and actuating device 32 can also be specifically set up and configured in such a way that the bearing carriage 30 of the lever-arm bearing 28 is moved forward from its initial position along the guide 30 counter to the x direction or has at least one such movement section.

### LIST OF REFERENCE SIGNS

1 vehicle roof
2 vehicle
3 roof system
4 panel
5 roof opening
6 rear edge
7 rear roof surface
8 roof-system frame
9 water chamber
10 sealing arrangement
11 wind-deflector apparatus
12 wind-deflector lamella
13 front roof surface
14 windshield
15 bearing device
16 front edge
17 fixed bearing
18 retaining structure
19 roof frame
20 adjusting device
21 actuating structure
22 underside
23 rear edge
24 region
25 edge side
26 lever arm
27 supporting limb
28 lever-arm bearing
29 bearing carriage
30 guide
31 seal
32 drive and actuating device
33 connecting element
34 pivot bearing
35 transverse pivot axis
36 retaining structure

1. A vehicle roof having a wind-deflector apparatus, which has an open-out wind-deflector lamella and an adjusting device for adjusting the wind-deflector lamella,
wherein the wind-deflector lamella can be adjusted between a rest position, in which it forms a roof portion of a roof surface of the vehicle roof, and at least one functional position, in which it has been pivoted out, by way of its rear edge, relative to the roof surface,
wherein the adjusting device has an actuating structure, and
wherein the wind-deflector lamella is both inherently rigid and formed so as to be elastically deformable in such a way that, when the wind-deflector lamella is being pivoted out into its functional position, the adjusting device deforms the wind-deflector lamella by the actuating structure and imparts a convexly curved configuration to the wind-deflector lamella.

2. The vehicle roof according to claim 1, wherein the vehicle roof has an exposable roof opening, which can be optionally closed or at least partially exposed by an adjustable closure unit, and the wind-deflector lamella is arranged in front of this exposable roof opening of the vehicle roof.

3. The vehicle roof according to claim 1, wherein the wind-deflector lamella can be deformed or is deformed with a longitudinal curvature and/or with a transverse curvature.

4. The vehicle roof according to claim 1, wherein, in the region of its front edge, the wind-deflector lamella is mounted on the roof by a bearing device, wherein the bearing device either is formed in such a way that it retains the wind-deflector lamella in a fixed position or is formed in such a way that it retains the wind-deflector lamella such that it can be pivoted about a transverse pivot axis by a pivot bearing.

5. The vehicle roof according to claim 1, wherein the actuating structure is arranged on an underside of the wind-deflector lamella.

6. The vehicle roof according to claim 1, wherein the actuating structure subjects the wind-deflector lamella to a bending moment which deforms the wind-deflector lamella.

7. The vehicle roof according to claim 1, wherein the actuating structure has at least one lever arm, which on the one hand is connected in a moment-transmitting manner to the wind-deflector lamella at a distance from the bearing device, which is assigned to the front edge of the wind-deflector lamella, and on the other hand is mounted in a pivotable manner on the roof by way of a lever-arm bearing.

8. The vehicle roof according to claim 7, wherein the lever-arm bearing is arranged in an adjustable manner along a roof-mounted guide and can be actuated by a drive and actuating device of a, or of the, closure unit or of the panel, the closure unit or panel being provided for optionally closing or exposing the exposable roof opening of the vehicle roof.

9. The vehicle roof according to claim 1, wherein, as seen in the transverse direction of the roof along the wind-deflector lamella,
the actuating structure or the lever arm extends over the width of the wind-deflector lamella or
the actuating structure has at least two actuating-structure units or lever arms one beside the other over the width of the wind-deflector lamella, which can be adjusted differently in relation to one another.

10. The vehicle roof according to claim 7, wherein the lever-arm bearing has a pivotable bearing spindle or a tube element, which extends over the width of the wind-deflector lamella and on which the actuating structure or the lever arm is fixed.

11. The vehicle roof according to claim 1, wherein the adjusting device is actuated in dependence on the speed of the vehicle and/or on the air flow to be conducted or is actuated in a predefined manner.

12. The vehicle roof according to claim 2, wherein the adjustable closure unit is a panel, and the wind-deflector lamella is arranged in front of this exposable roof opening of the vehicle roof.

13. The vehicle roof according to claim 11, wherein the predefined manner is in dependence on a respective position of the closure unit or of the panel or by a control-logic means.
